(19) United States
(12) Patent Application Publication
(10) Pub. No.: US 2018/0164109 A1
(43) Pub. Date: Jun. 14, 2018

(54) DYNAMIC MAP PRE-LOADING IN VEHICLES

(71) Applicant: Faraday&Future Inc., Gardena, CA (US)

(72) Inventors: Xiufeng Song, San Jose, CA (US); Christopher Keir Campbell, Cupertino, CA (US)

(21) Appl. No.: 15/662,657

(22) Filed: Jul. 28, 2017

Related U.S. Application Data
(60) Provisional application No. 62/368,820, filed on Jul. 29, 2016.

(51) Int. Cl. G01C 21/34; G01C 21/36

(52) U.S. Cl. CPC G01C 21/3484; G01C 21/362; G01C 21/3617

(57) ABSTRACT

Methods, systems, and apparatuses to predict a future position of a vehicle travelling along a path; determine, based on the predicted future position of the vehicle, a subset of map data from a set of map data stored in a data repository housed in the vehicle; and dynamically pre-load the determined subset of map data from the data repository to a cache memory storage housed in the vehicle for expedited access of the determined subset of map data by at least one computation unit housed in the vehicle.

### CROSS-REFERENCE TO RELATED APPLICATIONS

This application claims the benefit of U.S. Provisional Application No. 62/368,820, filed Jul. 29, 2016, the entirety of which is hereby incorporated by reference.

### BACKGROUND

Aspects of the disclosure relate to loading of maps data in a vehicle on a road. Typically, while driving, a vehicle's systems can access maps from a data storage memory containing information such as available paths or portions thereof, between a source and a destination. As maps increase in size to include more details, their access time from the data storage memory by the vehicle's processor(s) also increases, creating undesirable delays in providing the map data to a vehicle's driver or automated driving system. Exemplary embodiments of the disclosure address these problems, both individually and collectively.

### SUMMARY

Certain embodiments are described for dynamic map pre-loading in vehicles on roads. An exemplary embodiment includes an apparatus having at least one computation unit housed in a vehicle; a cache memory storage housed in the vehicle and configured to provide data to the at least one computation unit; a data repository housed in the vehicle, the data repository including a set of map data; and a map loading system configured to (a) predict a future position of a vehicle travelling along a path, (b) determine, based on the predicted future position of the vehicle, a subset of map data from the set of map data stored in the data repository, and (c) dynamically pre-load the determined subset of map data from the data repository to the cache memory storage for expedited access of the determined subset of map data by the at least one computation unit.

Another exemplary embodiment includes an apparatus having a means for predicting a future position of a vehicle travelling along a path; means for determining, based on the predicted future position of the vehicle, a subset of map data from a set of map data stored in a data repository housed in the vehicle; and means for dynamically pre-loading the determined subset of map data from the data repository to a cache memory storage housed in the vehicle for expedited access of the determined subset of map data by at least one computation unit housed in the vehicle.

Another exemplary embodiment includes a method comprising predicting a future position of a vehicle travelling along a path; determining, based on the predicted future position of the vehicle, a subset of map data from a set of map data stored in a data repository housed in the vehicle; and dynamically pre-loading the determined subset of map data from the data repository to a cache memory storage housed in the vehicle for expedited access of the determined subset of map data by at least one computation unit housed in the vehicle.

### BRIEF DESCRIPTION OF THE DRAWINGS

Aspects of the disclosure are illustrated by way of example. In the accompanying figures, like reference numbers indicate similar elements.

FIG. 1 illustrates an example environment in which various aspects of the disclosure can be implemented.

FIG. 2 includes a block diagram further illustrating various components for implementing aspects of the disclosure.

FIG. 3 illustrates exemplary operation flows of various aspects of the disclosure.

FIGS. 4A-4D in conjunction with FIGS. 1-3, further illustrate exemplary operation flows of various aspects of the disclosure.

### DETAILED DESCRIPTION

Examples are described herein in the context of dynamic map pre-loading in vehicles on roads. Embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

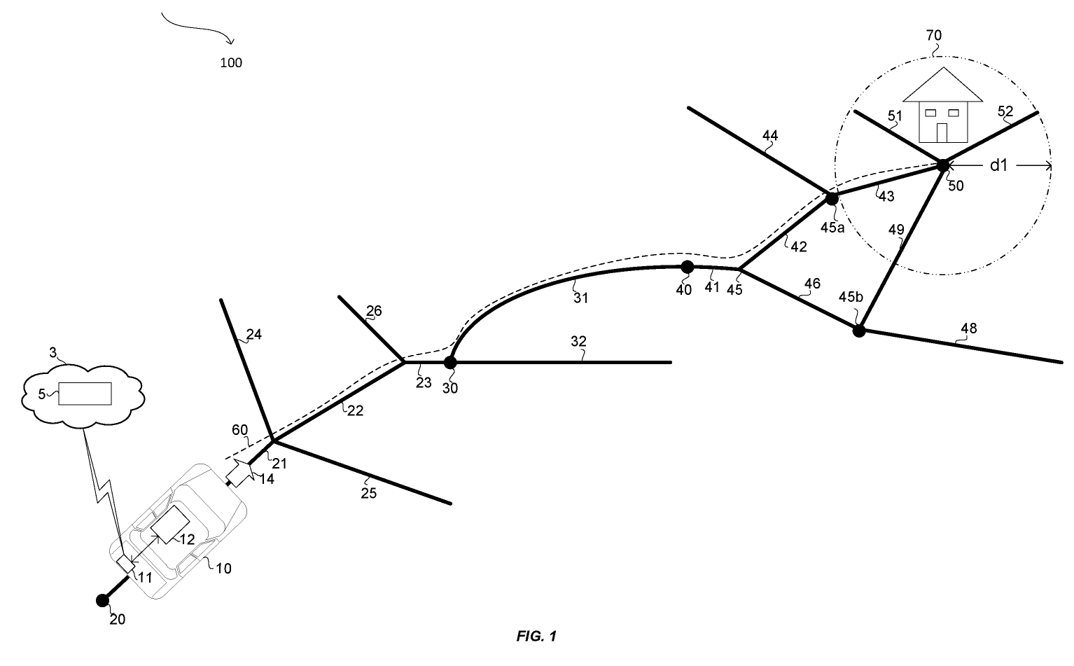

FIG. 1 illustrates an example environment 100 in which the various aspects of the disclosure can be implemented in the exemplary context of dynamic map pre-loading in vehicles on roads. As shown in FIG. 1, a vehicle 10 is travelling in the direction of arrow 14 from a start point 20 and along a dotted-line path 60 to a final destination 50. Vehicle 10 includes a map routing unit 12, and communication device(s) 11, such as wireless communication device(s), to communicate with a remote server 5, such as in a data cloud 3.

As shown in FIG. 1, path 60 includes road segments 21, 22, 23, 31, 41, 42, and 43. Example environment 100 also includes other pertinent road segments, such as 48, and those which intersect path 60, such as 24, 25, 26, 32, 44, 46, 49, 51, and 52.

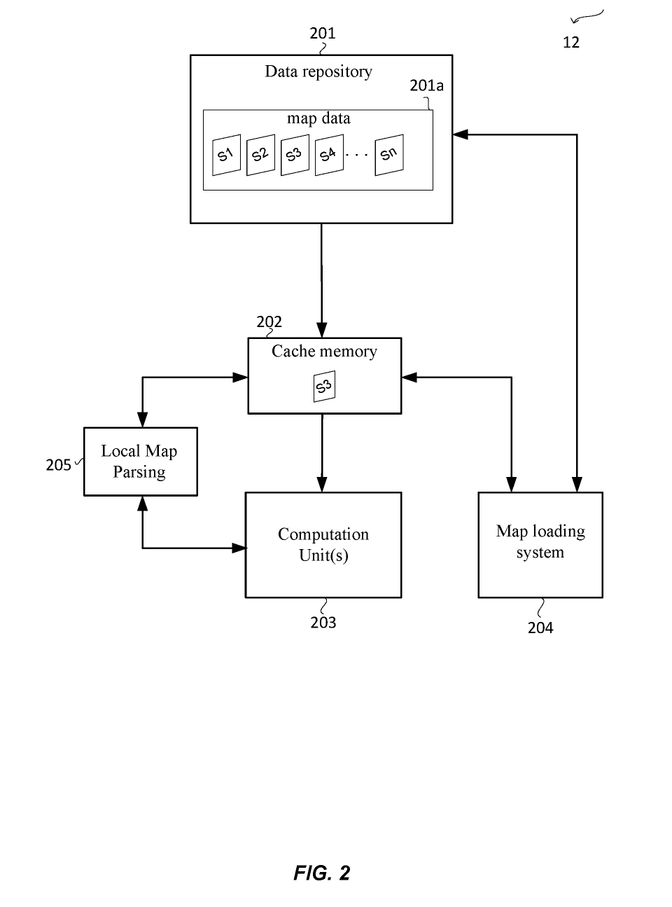

FIG. 2 includes a block diagram further illustrating map routing unit 12 for implementing aspects of the disclosure. As shown in FIG. 2, map routing unit 12, housed in vehicle 10, includes computation unit(s) 203, such as processor(s) or computational cluster(s). Map routing unit 12 further includes a data repository 201 containing map data such as a set of map data 201a for environment 100 to assist vehicle 10 in its journey to its final destination 50. For example, as shown in FIG. 2, the set of map data 201a includes map data subsets S1 through Sn which contain data for portion(s) of one or more road segments 21, 22, 23, 24, 25, 26, 31, 41, 42, 43, 44, 46, 48, 49, 51 and 52, as well as other mapping data. In an exemplary embodiment, set of map data 201a includes high-definition (HD) map data.

Map routing unit 12 also includes a cache memory storage 202, to provide map data, such as one or more of map data subsets S1 through Sn, to computation unit(s) 203. In an exemplary embodiment, a local map parsing unit 205 manages the interactions (e.g. cache data requests, etc.) between cache memory storage 202 and computation unit(s) 203.

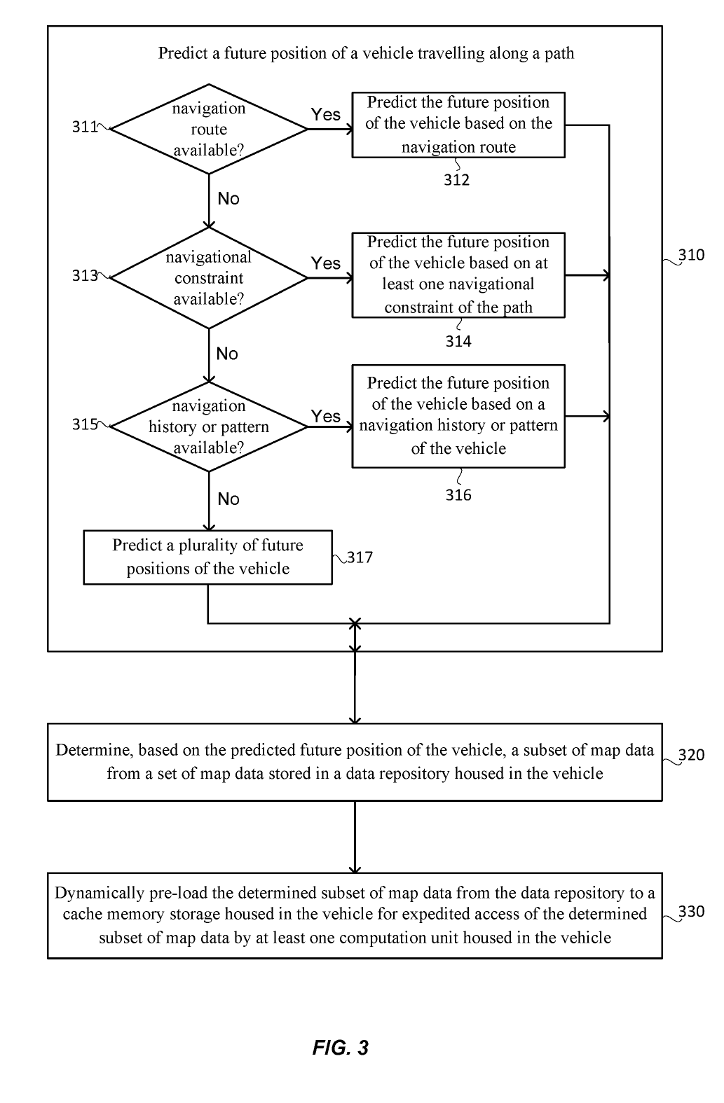

Map routing unit 12 further includes a map loading system 204. As described later and in greater detail in conjunction with FIG. 3, map loading system 204 is configured to (a) predict a future position of vehicle 10 travelling along path 60, (b) determine, based on the predicted future position of vehicle 10, subset(s) of map data (such as S3) from set of map data 201a (such as S1 through Sn) stored in data repository 201. Map loading system 204 is further configured to dynamically pre-load the determined subset of map data (such as S3) from data repository 201 to cache memory storage 202 for expedited access of the determined subset of map data (such as S3) by computation unit(s) 203. In an exemplary embodiment, access of map data for computation unit(s) 203 from cache memory storage 202, such as a Random-Access Memory (RAM) or other volatile memory storage, substantially reduces data access time, such as by an order of magnitude, compared to data access time from data repository 201, such as a hard disk or other non-volatile memory storage.

In the exemplary embodiment shown in FIG. 2, map loading system 204 and computation unit(s) 203 reside in separate computation systems, although it is contemplated that both map loading system 204 and computation unit(s) 203 may reside in one computation system.

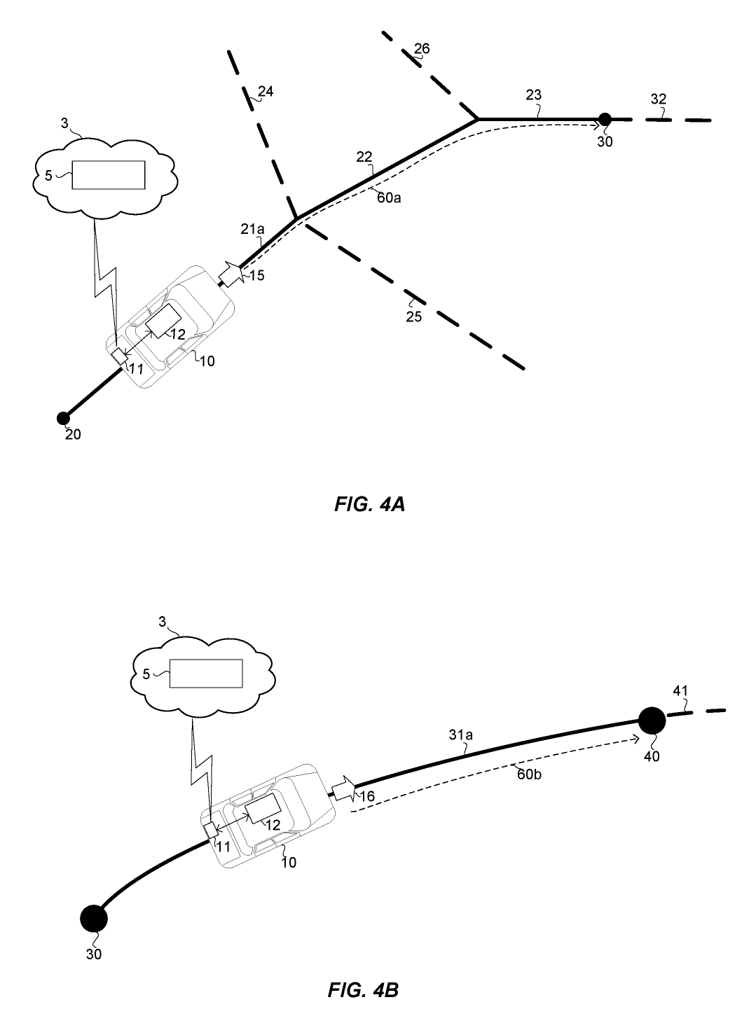

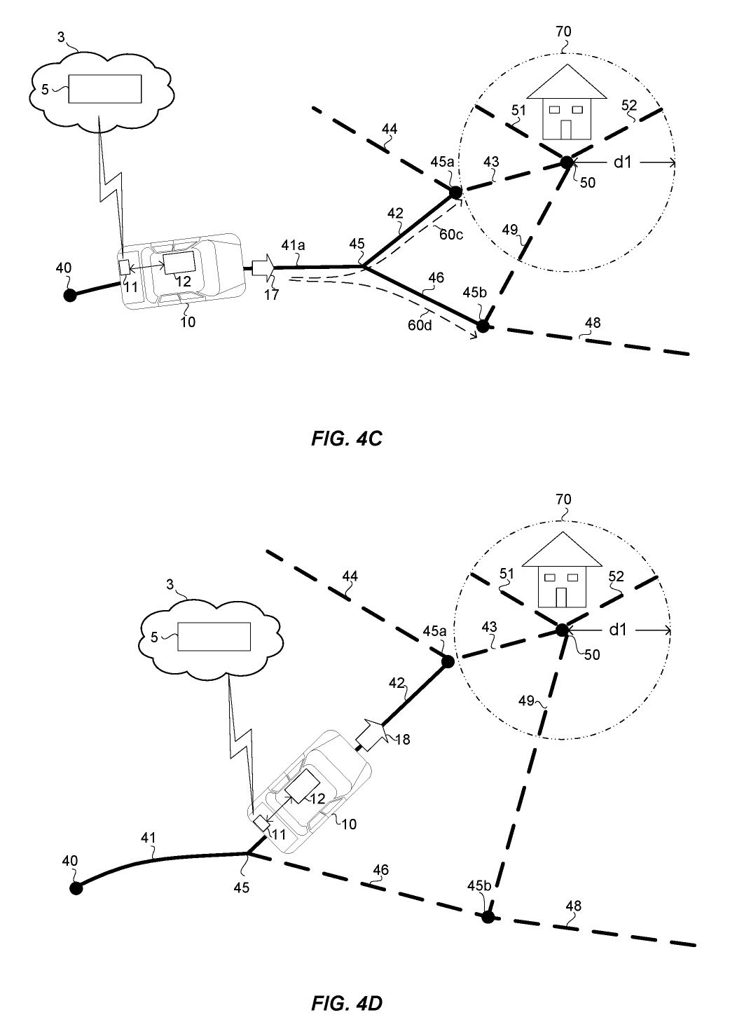

FIG. 3 illustrates exemplary operation flows of map loading system 204. Starting in block 310, a future position of vehicle 10 travelling along a path 60 is predicted. In an exemplary embodiment, prediction(s) in blocks 312, 314, 316 and 317 are made based on determination factors(s) such as availability of (a) navigation route, in decision block 311, (b) navigational constraint, in decision block 313, and (c) navigation history or driving patterns, in decision block 315, as further described below and in greater detail in conjunction with FIGS. 4A-D. It should be noted that the types of prediction(s) shown in blocks 312, 314, 316, 317, as well as the order of decision making shown in blocks 311, 313, and 315, are exemplary only, and other types of prediction(s) as well as different orders of decision making can also be used and are contemplated to be within the scope of the present disclosure.

Next, in block 320, based on the predicted future position of vehicle 10, a subset of map data, such as S3 shown in FIG. 2, is determined from set of map data 201a stored in data repository 201, as further described below and in greater detail in conjunction with FIGS. 4A-D.

Next, in block 330, the determined subset of map data, such as S3, is dynamically pre-loaded from data repository 201 to cache memory storage 202 for expedited access of the determined subset of map data, such as S3, by computation unit(s) 203.

FIGS. 4A-4D in conjunction with FIGS. 1-3, further illustrate exemplary operation flows of various aspects of the disclosure. FIG. 4A further illustrates the prediction(s) based on navigation route availability made in blocks 311 and 312 of FIG. 3, in the context of road segments 21-26 and 31 previously shown in FIG. 1.

As shown in FIG. 4A, vehicle 10 is travelling in the direction of arrow 15 from a start point 20. Navigation route information, such as for a known pre-selected path to a destination, are determined to be available in block 311. In the example shown in FIG. 4A, navigation route information, as illustrated by dotted line path 60a, includes road segments 22, 23 and 21a (a portion of road segment 21 yet to be traveled by vehicle 10). In block 312, a future position of vehicle 10 (ahead of its current position), such as position 30, is determined along path 60a based on a velocity of vehicle 10 and a predetermined time period (e.g. 2 minutes).

Based on predicted future position 30, subset(s) of map data (e.g., S3 in data repository 201) is determined, as previously described in block 320 of FIG. 3. As shown in FIG. 4A, the determined subset(s) of map data includes map data which corresponds to portion(s) of path 60a between a current position of vehicle 10 and the predicted future position 30, such as road segments 21a, 22, and 23. The determined subset(s) of map data, such as S3, are then dynamically pre-loaded from data repository 201 to cache memory storage 202, as previously described in block 330 of FIG. 3. Other subset(s) of map data in data repository 201, such as S1, S2, and S4 through Sn pertaining to road segments 24, 25, 26 and 32, do not correspond to the navigation route represented by path 60a and are thus not pre-loaded into cache memory storage 202, according to the present embodiment of map data pre-loading based on navigation route. In FIG. 4A, dashed-lines symbolically represent excluded road segments 24, 25, 26 and 32. Computation unit(s) 203 therefore will have expedited access to map data for path 60a, on which vehicle is predicted to travel until reaching position 30.

FIG. 4B further illustrates the prediction(s) based on navigational constraint(s) availability made in blocks 313 and 314 of FIG. 3, in the context of road segments 31 and 41 previously shown in FIG. 1, with road segment 31a representing a portion of road segment 31 (along path 60b) yet to be traveled by vehicle 10 in the direction of arrow 16.

As shown in FIG. 4B, navigational constraint(s), such as lack of exits for vehicle 10 to take along road segment 31a, are used to determine that vehicle 10 will remain on road segment 31a, and thus predict a future position of vehicle 10 (ahead of its current position), such as position 40, based on a velocity of vehicle 10 and a predetermined time period (e.g. 2 minutes). For example, even in the absence of a particular navigation route, or a known final destination chosen by the driver of vehicle 10, a prediction can be made regarding where vehicle 10 is likely to travel, based on knowledge of navigation constraints such as the lack of exits along road segment 31a.

Based on predicted future position 40, subset(s) of map data (e.g., S3 in data repository 201) is determined, as previously described in block 320 of FIG. 3. As shown in FIG. 4B, the determined subset(s) of map data include map data which corresponds to portion(s) of the path 60b between a current position of vehicle 10 and predicted future position 40, such as road segment 31a. The determined subset(s) of map data, such as S3, are then dynamically pre-loaded from data repository 201 to cache memory storage 202, as previously described in block 330 of FIG. 3. Other subset(s) of map data in data repository 201, such as S1, S2 and S4 through Sn, pertaining to road segment 41, are thus not pre-loaded into cache memory storage 202, as illustrated by dotted-lines symbolically representing excluded road segment 41. Computation unit(s) 203 therefore will have expedited access to map data for path 60b on which vehicle is predicted to be travelling until reaching position 40.

In an exemplary embodiment, a future position of vehicle 10 can be determined based on a navigation history or a navigation pattern of vehicle 10, which are then used to determine future path(s) of vehicle 1, as shown in blocks 315 and 316. For example, in FIG. 4A, if vehicle 10 has previously repeatedly taken path 60a, thus establishing a navigation history or pattern in regards to path 60a, then a future position 30 can be determined based on a velocity of vehicle 10 and a predetermined time period (e.g. 2 minutes) along path 60a. In an exemplary embodiment, navigation history or navigation pattern of vehicle 10 are stored in data repository 201, or alternatively are obtained for data repository 201 by map routing unit 12 via communication device(s) 11, from a remote server 5 in a data cloud 3.

FIG. 4C further illustrates the prediction(s) in block 317, in which more than one future positions of vehicle 10 are predicted, such as due to lack of available navigation route, navigational constraint(s), and navigation history or navigation pattern of vehicle 10.

In the example shown in FIG. 4C, vehicle 10 is travelling along road segment 41a, representing a portion of road segment 41 yet to be traveled by vehicle 10 in the direction of arrow 17. Map routing unit 12, however, is unable to accurately predict, following juncture 45, which of routes 60c or 60d will be taken by vehicle 10. Map routing unit 12 thus predicts future positions 45a and 45b along routes 60c and 60d, respectively, determined based on a velocity of vehicle 10 and a predetermined time period (e.g. 2 minutes).

Based on predicted future positions 45a and 45b, subset(s) of map data, such as S3 and S2 in data repository 201, are determined, as previously described in block 320 of FIG. 3. The determined subset(s) of map data includes map data, such as S3, which corresponds to portion(s) of path 60c between a current position of vehicle 10 and predicted future position 45a, such as road segment 41a and 42, as well as map data, such as S2, which corresponds to portion(s) of the path 60d between a current position of vehicle 10 and predicted future position 45b, such as road segment 41a and 46. The determined subset(s) of map data, such as S2 and S3, are then dynamically pre-loaded from data repository 201 to cache memory storage 202, as previously described in block 330 of FIG. 3.

Other subset(s) of map data in data repository 201, such as S1, and S4 through Sn pertaining to road segments 43, 44, 48, 49, 51 and 52, are thus not pre-loaded into cache memory storage 202, as illustrated by dotted-lines symbolically representing excluded road segments 43, 44, 48, 49, 51, and 52 in FIG. 4C. Computation unit(s) 203 therefore will have expedited access to the map data for the portions of paths 60c and 60d on which vehicle is predicted to be travelling until reaching positions 45a or 45b.

In an exemplary embodiment shown in FIG. 4D, once vehicle 10 has chosen one of paths 60c or 60d, such as by travelling along road segment 42 in the direction of arrow 18, or by entering an exit lane in road segment 41a for one of paths 60c or 60d, then subset(s) of map data, such as S2, which correspond to the non-chosen path 60d, such as for road segments 46 and 49, are marked for deletion or marked as available to be written over by new data in cache memory storage 202, as illustrated by dotted-lines symbolically representing marked road segments 46 and 49.

In an alternate exemplary embodiment, subset(s) of map data pre-loaded into cache memory storage 202 may correspond to road segment(s) in vicinity area 70 of a predicted future position of vehicle 10. For example in FIG. 4D, if destination 50 is determined as a predicted future position of vehicle 10, then subset(s) of map data corresponding to portion(s) of road segments 43, 49, 51 and 52 which are within a selected or determined radius dl of the destination 50 may be dynamically pre-loaded from data repository 201 to cache memory storage 202.

It is understood that the specific order or hierarchy of steps in the processes, such as those disclosed in FIG. 3 is an illustration of exemplary approaches. Based upon design preferences, it is understood that the specific order or hierarchy of steps in the processes may be rearranged. Further, some steps may be combined or omitted. The accompanying method claims recite various steps in a sample order. Unless otherwise specified, the order in which the steps are recited is not meant to require a particular order in which the steps must be executed.

The previous description is provided to enable any person skilled in the art to practice the various aspects described herein. Various modifications to these aspects will be readily apparent to those skilled in the art, and the generic principles defined herein may be applied to other aspects.

Operations described in the present disclosure may be controlled and/or facilitated by software, hardware, or a combination of software and hardware. Operations described in the present disclosure may be controlled and/or facilitated by software executing on various machines. Such operations may also be controlled and/or facilitated specifically-configured hardware, such as field-programmable gate array (FPGA) specifically configured to execute the various steps of particular method(s). For example, relevant operations can be implemented in digital electronic circuitry, or in computer hardware, firmware, software, or in a combination thereof. In one example, a device may include a processor or processors. The processor may be coupled to a computer-readable medium, such as a random access memory (RAM). The processor may execute computer-executable program instructions stored in memory, such as executing one or more computer programs. Such processors may comprise a microprocessor, a digital signal processor (DSP), an application-specific integrated circuit (ASIC), field programmable gate arrays (FPGAs), and/or state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, optical media, magnetic tape or other magnetic media, and/or any other medium from which a computer processor can read. The processor, and the processing, described may be in one or more structures, and may be dispersed through one or more structures. The processor may comprise code for carrying out one or more of the methods (or parts of methods) described herein.

The foregoing description has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method, comprising:
predicting a future position of a vehicle travelling along a path;
determining, based on the predicted future position of the vehicle, a subset of map data from a set of map data stored in a data repository housed in the vehicle; and
dynamically pre-loading the determined subset of map data from the data repository to a cache memory storage housed in the vehicle for expedited access of the determined subset of map data by at least one computation unit housed in the vehicle.

2. The method of claim 1, wherein the predicting is based on a navigation route of the vehicle.

3. The method of claim 1, wherein the predicting is based on at least one navigational constraint of the path.

4. The method of claim 1, wherein the predicting is based on at least one of a navigation history or a navigation pattern of the vehicle.

5. The method of claim 4, wherein the at least one of the navigation history or the navigation pattern of the vehicle is obtained from a remote server.

6. The method of claim 1, wherein the predicting is based on a velocity of the vehicle on the path.

7. The method of claim 1, the predicting further comprising:
predicting a plurality of future positions of the vehicle.

8. The method of claim 7, the determining further comprising:
determining a plurality of subsets of map data from the set of map data stored in the data repository.

9. The method of claim 8, the dynamically pre-loading further comprising:
dynamically pre-loading at least one of the determined plurality of subsets of map data from the data repository to the cache memory storage.

10. The method of claim 1, wherein the determined subset of map data corresponds to a portion of the path between a current position of the vehicle and the predicted future position of the vehicle.

11. The method of claim 1, wherein the determined subset of map data corresponds to the predicted future position of the vehicle.

12. The method of claim 1, wherein the predicting is based on (A) a velocity of the vehicle on the path and (B) at least one of (a) a navigation route of the vehicle, (b) at least one navigational constraint of the path, (c) a navigation history of the vehicle, or (d) a navigation pattern of the vehicle.

13. An apparatus, comprising:
at least one computation unit housed in a vehicle;
a cache memory storage housed in the vehicle and configured to provide data to the at least one computation unit;
a data repository housed in the vehicle, the data repository including a set of map data; and
a map loading system configured to (a) predict a future position of a vehicle travelling along a path, (b) determine, based on the predicted future position of the vehicle, a subset of map data from the set of map data stored in the data repository, and (c) dynamically pre-load the determined subset of map data from the data repository to the cache memory storage for expedited access of the determined subset of map data by the at least one computation unit.

14. The apparatus of claim 13, wherein the map loading system and the at least one computation unit reside in one computation system.

15. The apparatus of claim 13, wherein the map loading system and the at least one computation unit reside in separate computation systems.

16. The apparatus of claim 13, wherein the at least one computation unit comprising a computation cluster.

17. An apparatus, comprising:
means for predicting a future position of a vehicle travelling along a path;
means for determining, based on the predicted future position of the vehicle, a subset of map data from a set of map data stored in a data repository housed in the vehicle; and
means for dynamically pre-loading the determined subset of map data from the data repository to a cache memory storage housed in the vehicle for expedited access of the determined subset of map data by at least one computation unit housed in the vehicle.

18. The apparatus of claim 17, wherein the means for predicting the future position of the vehicle is based on at least one of (a) a navigation route of the vehicle, or (b) at least one navigational constraint of the path, or (c) a navigation history of the vehicle, or (d) a navigation pattern of the vehicle, or (e) a velocity of the vehicle on the path.

19. The apparatus of claim 18, further comprising:
means for obtaining at least one of the navigation history or the navigation pattern of the vehicle from a remote server.

20. The apparatus of claim 18, wherein the determined subset of map data corresponds to the predicted future position of the vehicle.
